(19) United States
(12) Patent Application Publication
(10) Pub. No.: US 2009/0174773 A1
(43) Pub. Date: Jul. 9, 2009

(54) Camera diagnostics

(76) Inventors: Jay W. Gowdy, Pittsburg, PA (US); Dean Pomerleau, Gibsonia, PA (US)

Correspondence Address: COGNEX CORPORATION;INTELLECTUAL PROPERTY DEPARTMENT, 1 VISION DRIVE, NATICK, MA, 01760-2077, US

(21) Appl. No.: 12/220,899

(22) Filed: Jul. 29, 2008

Related U.S. Application Data
(60) Provisional application No. 60/972,089, filed on Sep. 13, 2007.

(51) Int. Cl. H04N 7/18; H04N 17/00; G06K 9/00

(52) U.S. Cl. 348/148; 348/187; 382/107; 348/E17.002; 348/E07.085

(57) ABSTRACT

Per one example embodiment, apparatus may be provided. The apparatus may include memory and representations of camera diagnostics code and of other code including machine vision code. An image acquirer assembly may be provided, which is configured to take source images. Source images are provided for a camera diagnostics system formed by the camera diagnostics code and for a machine vision system formed by the machine vision code. The camera diagnostics system includes an obscurant detector configured to determine when the source images include artifacts representative of one or more obscurants intercepting a light path between a target object substantially remote from the image acquirer assembly and an imaging plane of the image acquirer assembly. The machine vision system includes machine vision tools configured to locate and analyze the target object in the source images when the target object is not obscured by the one or more obscurants.

### RELATED APPLICATION DATA

The present application claims priority to U.S. Provisional Patent Application No. 60/972,089, filed on Sep. 13, 2007, the content of which is hereby incorporated by reference in its entirety.

### FIELD OF THE DISCLOSURE

The present disclosure, in certain aspects, relates to methods or systems to determine when an image has unwanted artifacts, for example, due to condensation or obscurants between a target object and an imaging plane.

### BACKGROUND OF THE DISCLOSURE

Various systems have been developed for detecting obstructions in the field of view of a camera. Other systems have been developed for detecting when extraneous matter is on a translucent shield, for example, a vehicle windshield.

For example, Dean Pomerleau (an inventor herein) disclosed a process for estimating visibility from a moving vehicle using the “RALPH” vision system, in an IEEE article. Pomerleau, Visibility Estimation from a Moving Vehicle Using the RALPH System, Robotics Institute, Carnegie Mellon University, Article ref: 0-7803-4269-0/97 (IEEE 1998), pp. 906-911.

U.S. Pat. No. 4,867,561 (to Fujii et al.) discloses an apparatus for optically detecting extraneous matter on a translucent shield. By way of example, an embodiment is shown in FIG. 1, which includes a light-emitting device 22, installed at a point so that its light-emitting surface 221 faces a wiping portion of a windshield 10. See, for example, column 4, lines 4-8.

U.S. Pat. No. 6,144,022 (to Tenenbaum et al.) discloses a rain sensor, which uses statistical analyses. See, for example; columns 3 and 4 of this patent.

### SUMMARY

Per one example embodiment, apparatus may be provided. The apparatus may include memory, and representations of camera diagnostics code and of other code including machine vision code. An image acquirer assembly may be provided, which is configured to take source images. Source images are provided for a camera diagnostics system formed by the camera diagnostics code and for a machine vision system formed by the machine vision code. The camera diagnostics system includes an obscurant detector configured to determine when the source images include artifacts representative of one or more obscurants intercepting a light path between a target object substantially remote from the image acquirer assembly and an imaging plane of the image acquirer assembly. The machine vision system includes machine vision tools configured to locate and analyze the target object in the source images when the target object is not obscured by the one or more obscurants.

### BRIEF DESCRIPTION OF THE DRAWINGS

Embodiments are described in the detailed description as follows, by reference to the noted drawings, in which like reference numerals represent similar parts throughout the several views of the drawings, and wherein:

FIG. 1 is a block diagram of an image processing assembly, which includes both a camera diagnostics portion and another machine vision portion;

FIG. 2 is a block diagram of one embodiment of condensation detection apparatus;

FIG. 3 is a block diagram of one embodiment of obscurant detection apparatus;

FIG. 4 is a schematic representation of a camera view delineating image regions per one embodiment;

FIG. 5 is a flow chart of one embodiment of a condensation training process;

FIG. 6 is a flow chart of one embodiment of an obscurant training process;

FIG. 7 is a block diagram of a condensation classifier; and

FIG. 8 is a block diagram of an obscurant classifier.

### DETAILED DESCRIPTION

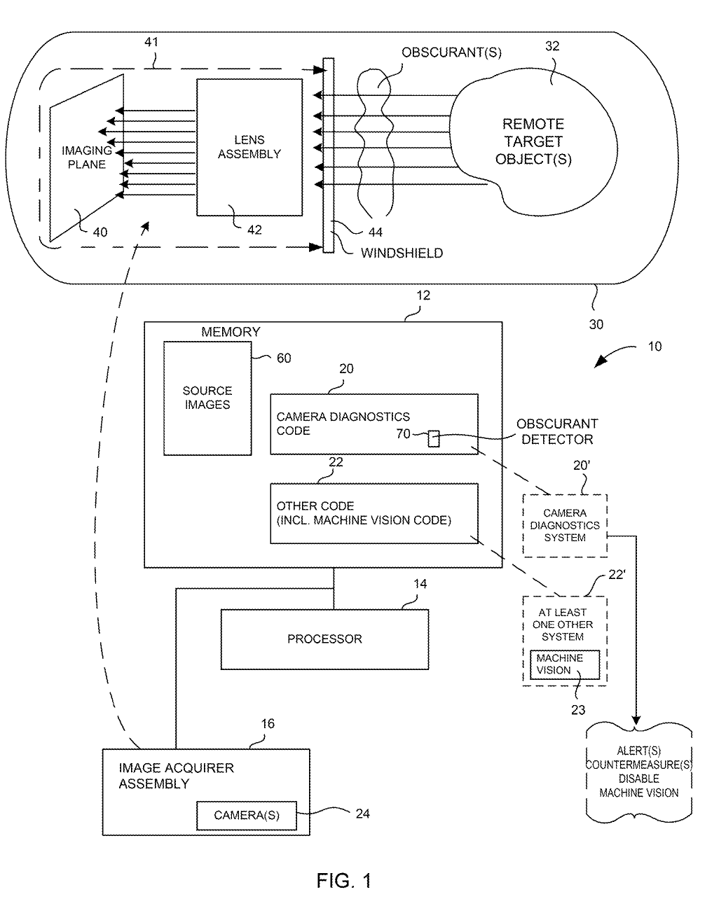

Referring now to the drawings in greater detail, FIG. 1 is a block diagram of an example image processing assembly 10, which includes camera diagnostics and other machine vision portions. The illustrated assembly 10 includes a memory 12, a processor 14, and an image acquirer assembly 16. The illustrated memory 12 includes one or more memory portions. Those portions may be memory units. By way of example, a memory unit may be one or more of a separate memory, a buffer, a random access memory, a hard disk, a register, and so on. The illustrated memory 12 may, for example, be a common memory “common” in the sense that it stores data for different functional subsystems of assembly 10. In the illustrated embodiment, memory 12 is common to camera diagnostics code 20 and other code 22. Memory 12 may optionally (per one embodiment) be in a single embedded device embodying the entire image processing assembly 10. Representations of camera diagnostics code 20 and other machine vision code 22 are each provided in the form of data encoded on computer-readable media. In the illustrated embodiment, they are stored in memory 12. The stored representations are configured to, when interoperably read by at least one processor (processor 14 in the illustrated embodiment), form respective systems, including a camera diagnostics system 20′ and at least one other system 22′ which includes a machine vision system 23.

The machine vision system 23 may be, for example, a vehicle vision system, for example, a lane departure warning, visual forward obstacle detection, and/or sign recognition system.

A camera diagnostics system, e.g., the illustrated system 20′, may be provided by itself (i.e., separate from another vision system). In addition, while this illustrated embodiment is directed to a vehicle vision system, a camera diagnostics system as disclosed herein may be used with other types of applications, including other machine vision applications. Per one example, a camera diagnostics system as disclosed herein may be incorporated into a factory floor machine vision system, in which case, for example, such a camera diagnostic system may determine when unwanted obscurants exists, such as a particulate matter accumulated on the lens of an imager. Moreover, a camera diagnostics system may be employed to detect obscurants when the imager(s) is/are fixed in one permanent position or when the imager(s) is/are moveable (e.g., when an imager is moved with a robotic arm in a factory floor application or when an imager is in a moving vehicle in a vehicle vision application).

Image acquirer assembly 16 includes one or more cameras 24. The assembly 16 is configured to take source images of target objects, remote from image acquirer assembly 16. Those source images, in the illustrated embodiment, include pixel images. The source images may include color, black and white, and/or gray level images. As illustrated in the upper portion of FIG. 1, in a breakaway portion 30, image acquirer assembly 16 is positioned in relation to certain target objects 32, so that an imaging plane 40 of image acquirer assembly 16 is remote from target object(s) 32.

A lens assembly 42 is provided between imaging plane 40 and target objects 32. One or more obscurants, including, for example, condensation obscurants or other obscurants, may be provided which interfere in the path between target objects 32 and imaging plane 40. Those obscurants may be between lens assembly 42 and target objects 32. By way of example, the obscurants may be on the outer surface of a windshield 44, on the inner (passenger-side) surface of windshield 44, or separate from the windshield (e.g., with fog).

The image acquirer assembly 16 produces and stores, in memory 12, source images 60. In this embodiment, source images 60 are provided for input to a camera diagnostics system 20 implemented with camera diagnostics code 20, and for input to the machine vision system 23 implemented by other code 22. While the illustrated embodiment contemplates plural images 60 being stored in memory 12, it is possible that a portion (or portions) of one or more images may be stored at a given time. For example, images could be processed “on the fly” (as they stream in from the imager).

The illustrated camera diagnostics subsystem includes an obscurant detector 70 configured to determine when source images 60 include artifacts representative of one or more obscurants intercepting a light path between target objects 32 substantially remote from image acquirer assembly 16 and from imaging plane 40.

The entire illustrated assembly 10 (or one or more portions thereof—e.g., image acquirer assembly 16) may be mounted (per the illustrated example embodiment) to a vehicle, for example, to the inside of the windshield of a vehicle. Accordingly, as shown in FIG. 1, a mount 41 may be provided which, in the illustrated embodiment, is configured to mount image acquirer assembly 16 to a moveable vehicle. The moveable vehicle (not shown in its entirety) may be a motor vehicle. More specifically, the mount may mount the illustrated assembly 10 behind a windshield of a motor vehicle (i.e., inside the passenger area of the vehicle).

When the illustrated assembly 10 of FIG. 1 is mounted in a moving vehicle, its images can become degraded in a variety of ways. If a vehicle vision system cannot quickly detect when its input is corrupted, then its results can be adversely affected; for example, the vehicle vision system could mistake artifacts originating from obscurants on the windshield or lens as being target objects. One objective of select aspects of the embodiments herein is to quickly, reliably, and passively detect (one or both of) two common types of image artifacts seen in images (generally, continuous streams, in the case of a vehicle vision application) from image acquirer assemblies mounted on moving vehicles: obscurants and condensation.

An obscurant may be some material or flaw that may prevent detail of an obscured part of one or more target objects from reaching the imager. In a vehicle vision system, for example, the material or flaw may be on an imager lens assembly or (if the imager is behind a windshield) on a windshield in front of the lens assembly. These obscurants may cover small or large areas of the image with any arbitrary shape. While not allowing important details of the target object(s) to reach the imager, obscurants may be translucent, and thus may vary in intensity (sometimes quite rapidly) with changes in overall ambient light reflected from the target objects(s) or with changes in incident light directly from a light source (such as the sun). In embodiments herein, constant obscurants are those obscurants that maintain roughly the same shape and position over time until they are removed.

Condensation may be a “fog” due to particles of water that may cover a large part of the image, and thus may significantly reduce the image quality. This fog can come from water condensation on the lens or windshield, or from water condensation in the air itself. When there is a significant amount of condensation, it may also register as a translucent obscurant, since, with enough condensation, important details of the image cannot be seen. Condensation generally covers large segments of the image at a time rather than being localized to any small arbitrary section of the image. Condensation generally will change in shape and intensity over time. In some embodiments, upon detecting condensation, countermeasures may be invoked to eliminate it.

Embodiments herein may be designed so that a camera diagnostics portion (e.g., camera diagnostics system 20′) monitors the quality of the same image stream that one or more vehicle vision systems (e.g., machine vision system 23) are using, without additional hardware.

Per select embodiments of the disclosure provided herein, a camera diagnostics system may be designed as a low cost, low impact software add-on to existing vehicle vision systems, such as lane departure warning, visual forward obstacle detection, or sign recognition, that can warn that vision system about obscurants and/or condensation in its field of view. Embodiments may include providing, for use with a vision system, one or more mechanisms to modify (e.g., disable) operation of functionality of the vision system and/or mechanisms that invoke countermeasures, such as wipers or defoggers.

A separate camera diagnostics hardware system with a separate imager, by contrast, will only diagnose the area over its separate imager, which may not be correlated with the quality of the image processed by the vision system as the vision system may be viewing a different part of the windshield than the separate camera diagnostics system. In addition, requiring a camera diagnostics system to have separate hardware may increase the hardware complexity and take up valuable areas of the windshield.

While certain embodiments herein rely on embodied software and thereby eliminate the need for separate camera diagnostics hardware (e.g., additional imager, memory, processor, and/or other hardware elements), the present disclosure is not intended to preclude the provision of separate camera diagnostics hardware, and embodiments herein may involve implementing aspects thereof with additional hardware.

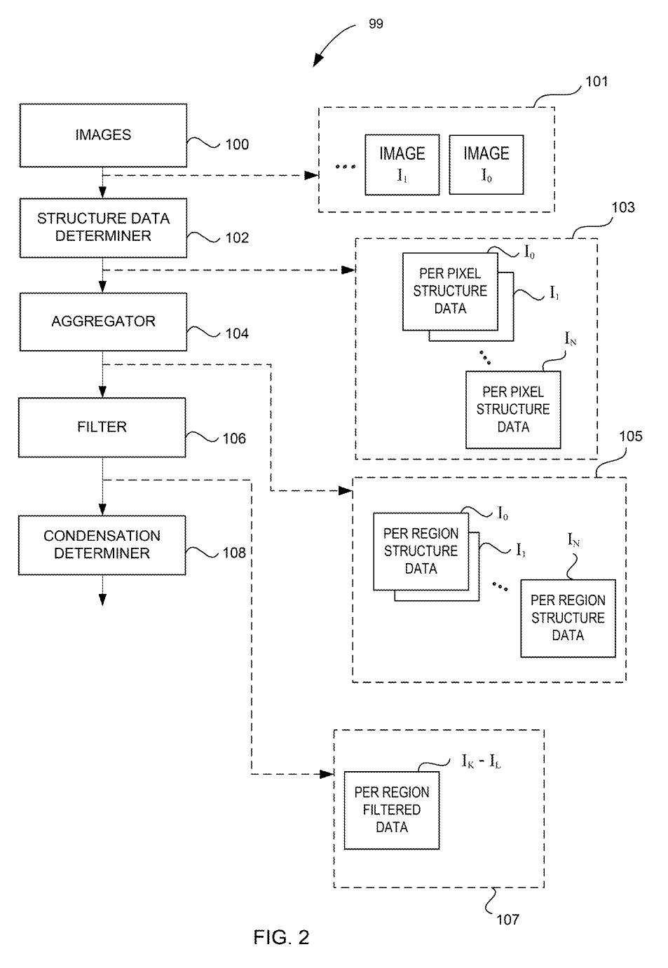

FIG. 2 is a block diagram illustrating one embodiment of condensation detection apparatus 99 which may form part of the camera diagnostic system 20′ of FIG. 1. The illustrated condensation detection apparatus 99 includes a plural image storage 100, a structure data determiner 102, an aggregator 104, a filter 106, and a condensation determiner 108. Plural image storage 100 may be configured to receive and store plural images including two-dimensional images. In the illustrated embodiment, it receives and stores two-dimensional images 101, which may, for example, include a continuous stream or a buffered sampling (subset) of a continuous stream of pixel images. As shown in FIG. 2, these images 101 include an image I₀ taken at a given time t₀, a next image I₁ taken at a given time t₁, and so on.

Structure data determiner 102 is configured to analyze the two-dimensional images it receives from image storage 100, and to produce, for each image, structure data indicative of the existence of structure at different areas in the two-dimensional image.

The “different areas” may be those areas of the image that correspond to meaningful information, i.e., to areas of the image likely to include image data concerning target objects when there are no unwanted artifacts.

In the illustrated embodiment, it is assumed that the entire image may contain meaningful information, and the different areas include areas centered at each pixel throughout the image. Structure data may be obtained for an area corresponding to a given pixel, e.g., by analyzing the given pixel and a range of neighbor pixels surrounding the given pixel. In this way, per-pixel structure data 103 (structure data corresponding to each pixel) is obtained by structure data determiner 102 for each analyzed image. By way of example, the range of neighbor pixels for a given pixel may extend to a 3×3 square grid “patch” centered at the given pixel.

As shown in FIG. 2, structure data determiner 102 produces per-pixel structure data 103, including per-pixel structure data for image I₀, per-pixel structure data for image I₁, . . . per-pixel structure data for image I_{N}.

Per-pixel structure data 103, per one embodiment, may include per-pixel spatial frequency statistics.

In the illustrated embodiment, per-pixel structure data includes edge-based feature values. These include an average edge intensity value, a minimum edge intensity value, a maximum edge intensity value, and a range of edge intensities, each of which is determined for an image area surrounding the given pixel. By way of example, the area surrounding the given pixel may be a 9×9 square grid “patch” of pixels, the center of which is the given pixel.

In the illustrated embodiment, the edge-based feature values (average edge intensity value, minimum edge intensity value, maximum edge intensity value, and range of edge intensities, each of an area corresponding to a given pixel) are determined using a Sobel edge detector. Other edge detectors could be used. Alternatively, for example, a difference of Gaussian (DOG) operator or a Roberts operator could be used to obtain edge-based feature values.

Other types of structure data that could be obtained in addition, or instead of, those noted for this embodiment include, for example, pixel intensity feature values including, e.g., median pixel intensity, a standard deviation of pixel intensities, and the kurtosis of pixel intensities, each value being for a particular area corresponding to a pixel.

Other data can be obtained that is considered structure data indicative of the existence of structure at different areas throughout the image. Such data may, for example, include feature values indicating one or more of the following: the occurrence of a line in an area of the image, defined as a pair of edges with a region therebetween; the occurrence of a finite area bounded by a closed edge, occurring within a given area of the image; the occurrence of one or more particular textures within the given area; the occurrence of abutting textures within the given area, thereby defining an edge; and color differences defining one or more edges within the given area. Feature values may be obtained using different processes and operations to represent these occurrences, and such feature values would then form part of the structure data.

Before structure data determiner 102 analyzes the image data to ascertain the structure data, the images may (optionally) be subjected to a high pass (image sharpening) operation to attenuate low spatial frequency components without disturbing high frequency information.

Aggregator 104 is configured to aggregate the per-area structure data (per-pixel structure data 103, in the illustrated embodiment) into a smaller set of per-region structure data for each image. Each of the regions encompasses a plurality of the different areas. In the illustrated embodiment, each image is divided into nine regions, including three regions across the top of the image, three regions across the middle of the image, and three regions across the bottom of the image. In the illustrated embodiment, the regions at the top of the image correspond to the sky, the three middle regions intersect with the horizon; and the three lower regions include portions of a road traveled upon by a vehicle.

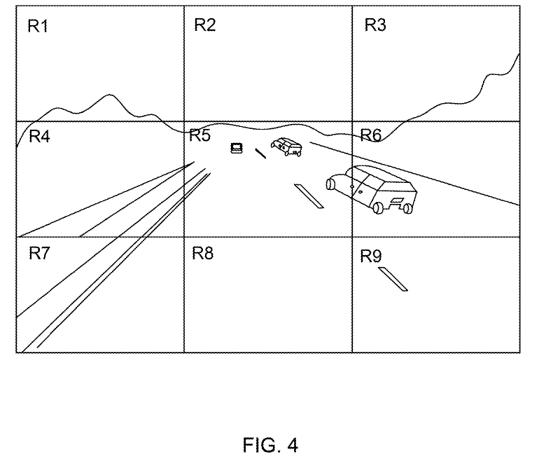

In the illustrated embodiment, the regions are equally divided from an image as shown in FIG. 4, to include regions R1, R2, R3, . . . R9.

The resulting per-region structure data 105, accordingly, includes per-region structure data for image I₀, per-region structure data for image I₁, . . . per region structure data for image I_{N}.

Aggregator 104 adds or combines structure data feature values across different areas into consolidated values for the entire region encompassing those areas. Accordingly, for the case where there are nine regions, a single set of structure data feature values will now exist for each of those regions R1-R9. For example, a given consolidated value for a region may be calculated by averaging all the corresponding values of the given feature for all the pixels in the region. Alternatively, the consolidated value could be the standard deviation of all the values of the given feature in the region.

In the illustrated embodiment, the per-region structure data includes an edge intensity average throughout the region, a maximum edge intensity throughout the region, a minimum edge intensity throughout the region; and a range of edge intensities (max. edge intensity minus min. edge intensity) throughout the region.

Filter 106 performs a smoothing operation by filtering the aggregated structure data over time. It may do this, for example, by integrating each feature value over time; obtaining a running average of each feature value (for example, over the last 100 images); or calculating an exponential decaying average of each of the feature values over a particular amount of time. The result of this operation is depicted in the illustrated embodiment in FIG. 2 as per-region filtered data 107, which corresponds to a range of images I_{K}-I_{L}.

With the exponential decaying average approach to filtering, a current given feature value e (e.g., an average edge intensity value) corresponding to a given pixel at the current time t is used to calculate éₜ, a filtered estimate value at time t, as follows:

éₜ=αéₜ₋₁+(1−α)e

Where éₜ₋₁ is a filtered estimate value calculated previously at time t−1, e is the given feature value at time t, and alpha is a mixing constant (some number between 0 and 1). When the first image is at time t, there is no image at time t−1. éₜ₋₁ is set to 0 in this case.

In the illustrated embodiment, alpha is set to a value so that a filtered estimate of a given feature value will reach its half life after about 10 seconds worth of images (i.e., after about 100 images, assuming a picture taking rate, e.g., of 10 frames per second).

Condensation determiner 108 is configured to determine when condensation exits at a given location in an image based upon a set of factors. The structure data including a value indicating that substantial structure exists at the given location (e.g., in a given region) is a factor in favor of a determination that no condensation exists at the given location. Condensation determiner 108 may be configured, e.g., to output determinations for each region of the image. Such determinations could include a determination that region R₀ has no condensation; that region R₁ has condensation; that region R₂ has an uncertain amount of condensation; and so on.

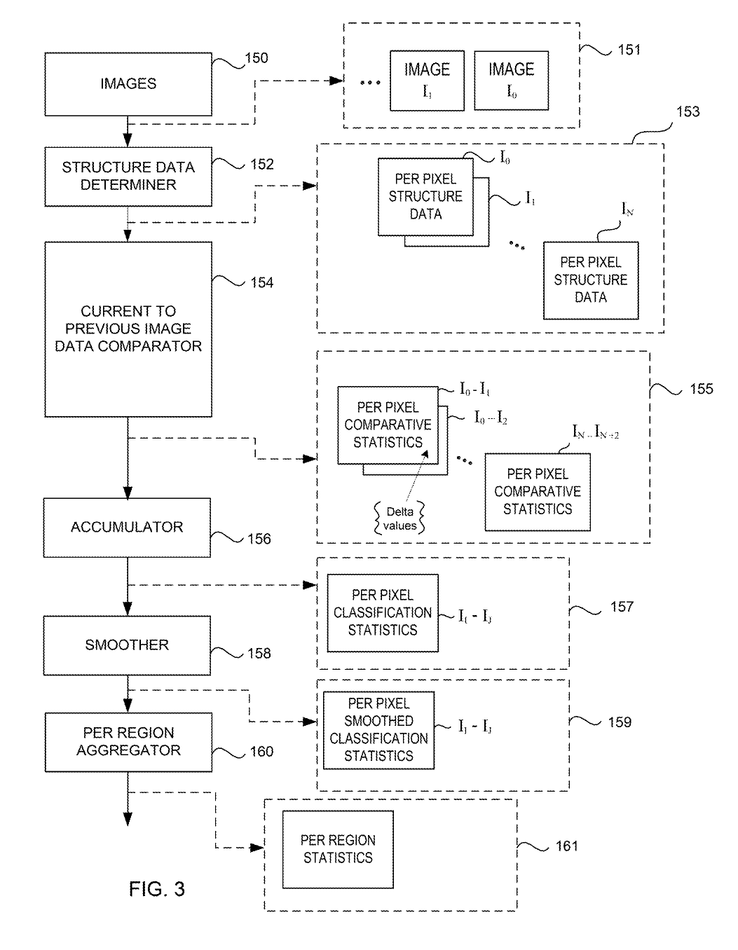

FIG. 3 is a block diagram of an embodiment of obscurant detection apparatus 149, which may form part of the illustrated camera diagnostics system 20′ of FIG. 1. The illustrated obscurant detection apparatus 149 includes image storage 150, a structure data determiner 152, a current to previous image data comparator 154, an accumulator 156, a smoother 158, and a per-region aggregator 160.

Image storage 150 may be configured to receive and store a stream of two-dimensional images. Accordingly, image storage 150 outputs a plurality of images 151, including an image I₀, at a given time to, a next image I₁, taken at a time t₁, and so on.

Structure data determiner 152 is configured to analyze two-dimensional images from among the plural images it receives and to produce structure data indicative of the existence of structure at different areas in the two-dimensional images. In the illustrated embodiment, this structure data is determined for the different areas throughout each of the analyzed two-dimensional images.

In the illustrated embodiment, the structure data includes a set of per-pixel structure data for each of the plurality of images I₀, I₁, . . . I_{N}. In the illustrated embodiment, the structure data includes edge-based feature values. These include an average edge intensity value, a minimum edge intensity value, a maximum edge intensity value, and a range of edge intensities, each of which is determined for an image area surrounding and including the given pixel.

The edge-based feature values may be obtained, e.g., using a Sobel edge detector, or a different type of edge detector, e.g., a difference of Gaussian (DOG) operator or a Roberts operator.

In addition, or instead of, edge-based feature values, pixel intensity feature values may be provided, e.g., including median pixel intensities, standard deviation of pixel intensities, and the kurtosis of pixel intensities.

Other data can be obtained that is considered structure data indicative of the existence of structure at different areas throughout the image. Such data may, for example, include feature values indicating one or more of the following: the occurrence of a line in an area of the image, defined as a pair of edges with a region there between; the occurrence of a finite area bounded by a closed edge, occurring within a given area of the image; the occurrence of one or more particular textures within the given area; the occurrence of abutting textures within the given area, thereby defining an edge; and color differences defining edges within the given area. Feature values may be obtained using different processes and operations to represent these occurrences, and such feature values would then form part of the structure data.

Current to previous image data comparator 154 may be configured to compare one or more first images of the plural images to one or more second images of the plural images, the one or more second images having been taken at times different than when the one or more first images were taken. The comparator determines an extent to which a given feature value at a given location common to the first and second images has changed substantially from the one or more first images to the one or more second images.

In the illustrated embodiment, the comparator determines a change in magnitude of a given edge-based feature value in the current image to its corresponding feature value in the immediately prior image. This is done for all feature values, for each image. Accordingly, delta values (per pixel comparative statistics) 155 are provided for a number of sets of images, including per pixel comparative statistics for images I₀-I₁ per-pixel comparative statistics for images I₁-I₂, . . . and such statistics for images I_{N}-I_{N+1}.

Suppose feature values include a maximum edge intensity value of 120 (a bright value out of a possible 0-256 levels) and a minimum edge intensity value of 50. Another feature value is the range of edge intensities, i.e., 70 for this given pixel. At a moment later, for example, for image I₁, the maximum edge intensity value is 240, and the minimum intensity value is 45. Accordingly, the max-min range feature value is 240 minus 45, i.e., 195. By comparing the range feature value in the current image I₁ to the corresponding range feature value in the previous image I₀, an absolute value of the difference in the values (70 minus 195) is 125, which is a substantial change. Because this change is substantial, it is a factor that weighs in favor of a conclusion that there is no obscurant at the location corresponding to the given pixel.

Generally speaking, in operation of the illustrated detection apparatus 149, images are obtained with a road directed imager, where the imager is fixed to a vehicle in one illustrated embodiment. These images are used to obtain structure data at a given location in the images. This information is gathered from plural images taken at different times. Then, first images are compared to second images at times different than when the first images were taken. This is done to determine when the structure data at the given location has changed substantially from the first images to the second images. This is also done to determine when the structure data at the given location has not changed substantially from the first images to the second images. When the structure data has changed substantially, this is a factor indicating that there is no obscurant at the given location. When the structure data at the given location has not changed substantially, this is a factor indicating that there is an obscurant at the given location.

Various other factors may be taken into account to affect how and how much the structure data should or should not be changing, and how that relates to a conclusion that there is or is not an obscurant at the given location. Those factors may include one or more of the speed of the camera in relation to the target objects (i.e., the speed of the vehicle in the vehicle mounted embodiment); the rate of turn of the camera (the rate of turn of the vehicle, in the vehicle embodiment); and the position of the given location within the image. Another factor is the time of day. For example, whether the image was taken during the day time or at night is a factor that could be taken into account.

An accumulator 156 is provided, which is configured to map the changed values pertaining to respective pixels to values indicative of the probability that there is an obscurant at those locations. In the illustrated embodiment, classification statistics including “probability that obscured” values are produced by accumulator 156, A set of per-pixel classifications statistics 157 will be provided by accumulator 156, which corresponds to a range of images, over a span of time, from an image I_{I} taken at a time “I” to an image I_{J} taken at a time “J”.

In the illustrated embodiment, a given edge intensity change value for a pixel may be two gray levels (indicating that the edge intensity for this pixel changed by two levels). This type of change is evidence that the pixel may be obscured, because if the given location is not obscured, a higher change value would have been expected.

In the illustrated embodiment, a lookup table derived from training data may be provided, having one input and two outputs. This change value (two levels) is input into the lookup table, and two numbers are output, a first number being the probability that this value (2) would be obtained if the pixel is obscured, and the other value being the probability that this value (2) would be obtained if the pixel is clear.

Those two probability numbers are then used by the accumulator 156 to obtain a classification value indicative of whether or not a given location is obscured or not. If the resulting value is negative, that means that the value is weighing towards a conclusion that there is an obscurant, while a positive value means that the value is weighing towards a conclusion that there is no obscurant (i.e., the given location is clear). This value may be a floating point number with a magnitude indicative of the confidence that the given location is obscurant or clear. The next value corresponding to the same pixel for the next image will be added to the current summed value.

This accumulated classification value is accumulated for a range of images, until a threshold value is reached. Alternatively, the classification value can be accumulated until some threshold time value has been reached. Then, the accumulated classification value is stored in the per-pixel classification statistics 157 associated with its corresponding pixel.

Depending upon the magnitude of the accumulated classification value, and its polarity (i.e., positive or negative), each pixel is classified as clear and given a value of 1 (if the value is above a positive threshold), classified as obstructed and given a value of −1 (if the value is below a negative threshold), or classified as uncertain and given a value of 0 (if the value is somewhere between the negative and positive thresholds).

Smoother 158 performs filtering over space of the classification statistics, in order to produce per-pixel smoothed classification statistics 159, corresponding to a range of images I_{I}-I_{J}. This “filtering” operation results in a filling of the “holes”. Various types of smoothing can be performed by smoother 158, including a median filer, blob analysis, the use of an array, a spatial low pass filter, and aggregation. The illustrated embodiment of smoother 158 employs the aggregation approach, which involves sanity checking each pixel's classification with its neighbors. For example, if a given pixel is classified as clear but it is surrounded by pixels classified as obscured, its classification will be changed.

Per region aggregator 160 may be provided which provides per region classifications statistics. By way of example, it may provide, for each region, the percentage of pixels that are classified as obstructed, the percentage of pixels that are classified as clear, and the percentage of pixels that are classified as uncertain. For example, for a given region Ri, twenty-five percent of the pixels may have been determined to be obstructed because they have a classification value of minus 1; fifty percent of the pixels in the region may have been classified as clear because they have a value of plus 1, and twenty-five percent of the pixels may have been classified as uncertain, because they have a value of zero.

For each of the apparatuses in FIGS. 2 and 3, different statistical and mathematical approaches can be utilized to present a conclusion and a level of certainty with which a conclusion was reached regarding whether there is an obscurant or condensation in a region or at a particular sub-region location in an image (or throughout the entire image).

Each of the condensation detection and obscurant detection apparatuses shown in FIGS. 2 and 3 may be configured based upon experience, upon empirical data, by making certain assumptions, or by performing automatic and/or mechanized training approaches. Accordingly, they may be trained or not trained. Training could occur by automated means or by human intervention. For example, a hand-developed decision tree could be utilized. Alternatively, an expert system could be utilized. A classification system could be developed manually, through a machine learning procedure.

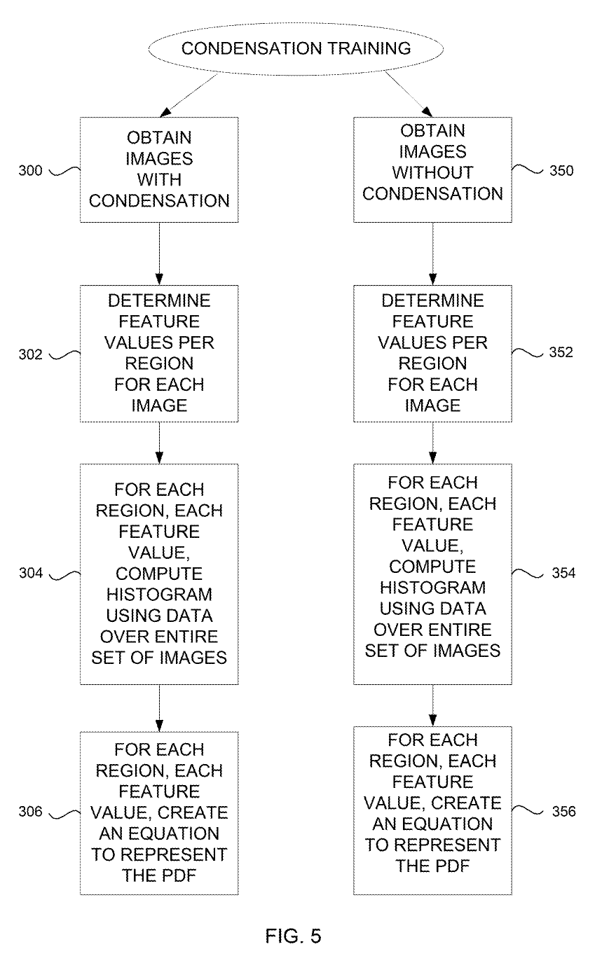

One example embodiment of a training approach is provided for each of the obscurant and condensation detection apparatuses described herein. The condensation training approach in accordance with one embodiment will be described as follows. As shown in FIG. 5, data gathering acts 300 and 35 are performed, at which point sets of images with condensation and images without condensation are obtained and analyzed. By way of example, a vehicle with an imager fixed thereto may be driven in different situations, for example, different weather conditions. The vehicle may be driven at different times of the day. Meanwhile, the imager may obtain thousands of images at a rate, for example, of ten frames per second. This may be done to obtain images while there is condensation on the windshield of the vehicle, and also when there is no condensation either on the windshield or in the atmosphere, for example, in the form of fog.

Thereafter, a number of acts are performed in order to obtain certain equations based upon the condensation information and other equations based upon images without condensation. In act 302, feature values are determined for each region for each image. In the illustrated embodiment, those feature values include the average edge value, the maximum edge value, and the range of intensities (i.e., the maximum edge intensity value minus the minimum edge intensity value). Thereafter, in act 304, for each region, and for each feature value for a given region, a histogram is computed using data over the entire set of images. For a given region R₁, for a given feature value, that feature value may have 256 possible levels. Accordingly, a total of 256 bins may be provided, each bin accumulating the number of times that the feature value is at the level corresponding to that bin. This count is performed for all of the images. Then, these bins are converted to a histogram which indicates the probability that each feature value will occur, for the entire region, for all data sets, i.e., all images that were obtained and analyzed.

In a next act 306, for each region, and each feature value, an equation is created to represent the probability density function (PDF). This may be done by fitting the histogram to a mathematical equation, which may, for example, include a mixture of weighted Gaussians. It is possible to model the equation with a mixture of three Gaussians. In some cases, just one Gaussian is sufficient. These equations are functions that represent the probability density function.

Similar to acts 302, 304, and 306, acts 352, 354 and 356 are performed with the images that were obtained that do not contain condensation. Accordingly, in act 352 a determination is made of the feature values per region, for each image that is without condensation. Thereafter, in act 354, for each region, and each feature value, a histogram is computed using data over the entire set of images (in this case, images without condensation). Thereafter, in act 356, for each region, and each feature value, an equation is created to represent the probability density function.

The equation created at act 306 has an output that will be the probability that this value occurs given that there is condensation, where the value is an average feature value filtered over time for a given region.

The output of the equation produced at act 356 will be the probability that the value input thereto will occur given that there is no condensation. The value that is input thereto will be a value that is an average feature value filtered over time for a given region.

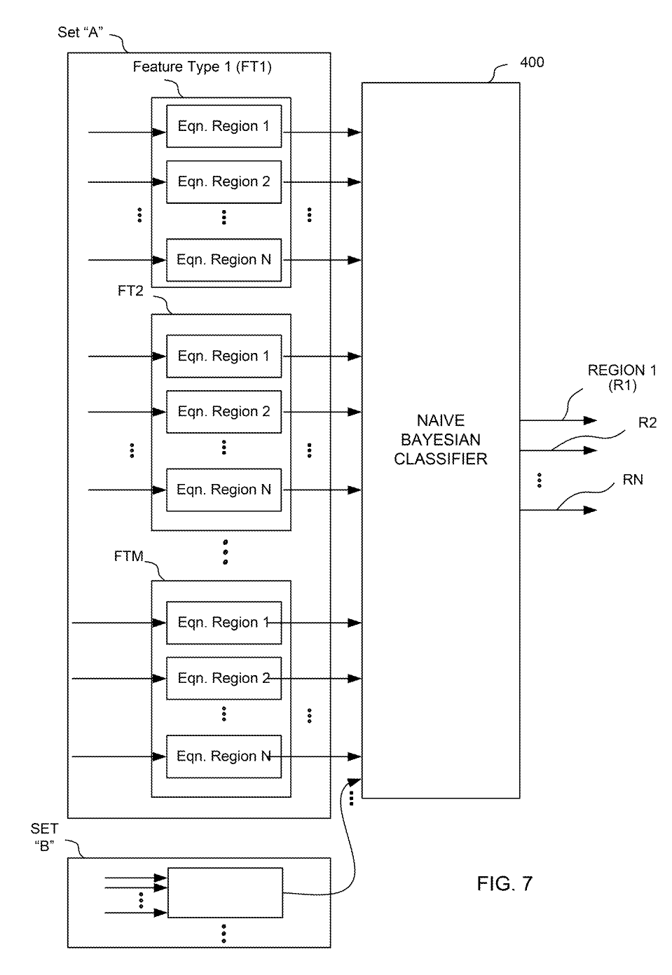

FIG. 7 shows a block diagram of a condensation classifier that may form part of the condensation determiner 108 shown in FIG. 2.

As shown in the condensation classifier in FIG. 7, act 306 is used to create a number of equations forming part of set A, and act. 356 is used to produce a number of equations forming part of set B.

For a particular feature type, for example, feature type one (FT1), a set of equations is provided, corresponding to each of the regions R1-RN. A next set of set a equations is provided for feature type 2 (FT2), i.e., for regions R1-RN. If there are a total of M feature types, this is continued for all the feature types, up to feature type M (FTM) which includes a set of corresponding equations for all of the regions in the image, i.e., regions R1-RN. In the illustrated embodiment, a feature type value is input equal to an average of the feature values for the given region, which values have been filtered over time.

As noted above, the equations for the respective regions in set A for each feature type each indicate the probability that the input value will occur given that there is condensation. The equations for each feature type for the respective regions in set B for each feature type each indicate the probability that the input value will occur given that there is no condensation. Each of these probabilities is input into a naïve Bayesian classifier 400 as shown in FIG. 7, which will then output a probability value “b” for each region.

First, for each region, a value is determined that represents the ratio of two numbers for a given feature type, which ratio is the probability that the input value will occur given that there is condensation divided by the probability that the input value will occur given that there is not condensation.

These ratios are multiplied together across all feature types for a given region in order to obtain a single value for region R₁, a single value of region R₂, and so on including a value for region R_{N}. Each of these values is the ratio of a probability that the region has condensation verses the probability that it has no condensation given all feature type values for that region.

The product of the ratios is then multiplied by the ratio of an a priori estimate of the probability that a region has condensation to an a priori estimate of the probability that a region does not have condensation. This ratio is empirically chosen to bias the answer one way or the other, i.e., to adjust the strength of evidence required for classifying regions has being covered in condensation.

This final product of ratios, “c”, now known, equals a ratio of b/a, where it is also know from the laws of probability that a+b=1.

Accordingly, one may solve for b using the following equation: b/(1−b)=c

The value “b” represents the probability that there is condensation for the given region, which may be output of the condensation classifier, for example, forming part of condensation determiner 108 in the condensation detection apparatus shown in FIG. 2.

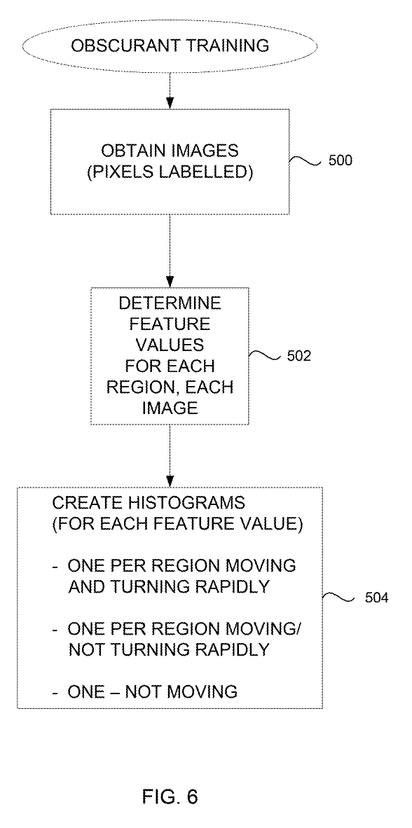

FIG. 6 shows a flow chart of an obscurant training process. In a first act 500, images are obtained. In the illustrated embodiment, the images are obtained using an imager fixed to a vehicle behind a windshield having predetermined obscurants, whereby the pixels that are obscured and the pixels that are not obscured are labeled as such. A number of varying images are obtained using the vehicle without changing the obscurants. For example, a sequence of images may be obtained from a single run of the vehicle without changing the obscurants. A few thousand images may be obtained, for example, at a rate of ten frames per second. The training may involve using a small set of different video sequences, for example, between two and seven different video sequences involving driving the vehicle at different speeds and at different times of day, including, for example, daytime and nighttime. The training images that are obtained at act 500 may also include training images that are obtained with images where there are no obscurants, i.e., all of the pixels are labeled as not obscured.

In act 502, the feature values are determined for each region, for each image. Thereafter, in act 504, histograms are created, for each feature value. One histogram is created per region, for the case where the vehicle is both moving and turning rapidly. One histogram is created per region, for the case where the vehicle is both moving and not turning rapidly. One histogram is created for the case where the vehicle is not moving.

A given feature may have 256 possible values; thus, for a given feature value, 256 bins may be provided to obtain a histogram. Each time the edge value is at a particular level corresponding to a particular bin (for example, level 10 corresponding to bin 10), the occurrence of that edge value is added to the total in that bin. The total amount of times that a given feature value is at a particular level for all of the images is tallied in each of the corresponding bins, and these numbers are then used to calculate statistics, including the percentage of times a particular value occurred. A histogram can be translated into a corresponding lookup table. By utilizing normalization, each bin may be divided by the sum of values in all the bins. This approximates a probability density function.

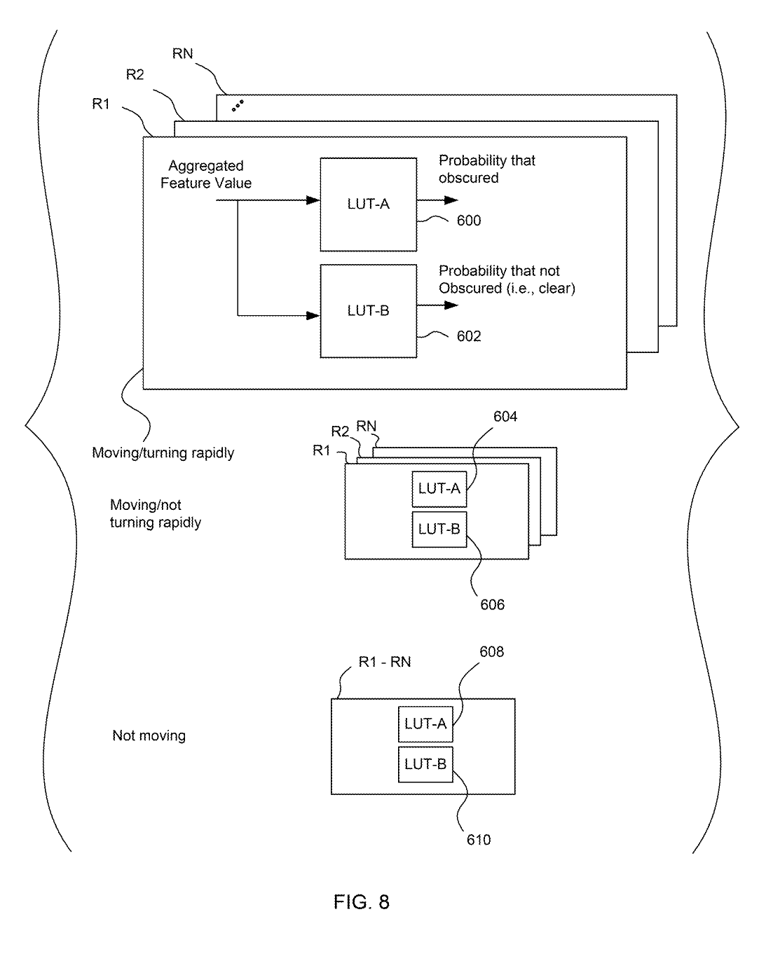

FIG. 8 shows a block diagram of an obscurant classifier that may form part of accumulator 156 of the obscurant detection apparatus shown in FIG. 3.

As shown in FIG. 8, an obscurant classifier may include a number of sets of lookup tables for regions R1, R2, . . . RN. For example, the lookup tables shown in FIG. 8 include lookup tables LUT-A 600 and LUT-B 602 which correspond to region R1 for a situation where the vehicle has been determined to be moving and to be turning rapidly. The lookup tables further include, for example, LUT-A 604 and LUT-B 606, corresponding to region R1, for the situation where the vehicle is moving but is not turning rapidly. The lookup tables may further include, for all of the regions R1-RN, lookup tables LUT-A 608 and LUT-B 610.

Each of these lookup tables includes, as an input value, an aggregated feature value, which, in the embodiment as shown in FIG. 3, includes a change value that corresponds to the entire region. The output of lookup table LUT-A 600 indicates the probability that the corresponding region is obscured given this input feature value. The output of lookup table LUT-B 602 indicates the probability that the region is not obscured (i.e., clear) given this input feature value as an input. The other lookup tables, including look up tables LUT-A 604, LUT-B 606, LUT-A 608, and LUT-B 610 include similar inputs and outputs.

In this embodiment, the statistics, and the relationships of those statistics to determinations of whether or not a particular region is obscured or not, will vary in accordance with whether a vehicle is moving or not moving, and whether the vehicle is turning rapidly or not turning rapidly. Accordingly, separate sets of lookup tables are provided to cover each of these cases. In addition, the relationship of the data and the output conclusions will vary in accordance with the region. In the illustrated embodiment, the regions of the image are divided into nine equal regions as shown in FIG. 4.

In the case of obscurant detection, the process may benefit from the use of smaller regions. Accordingly, rather than having a total of nine equal regions as shown in FIG. 4, a greater concentration of regions may be provided, to provide a more accurate calculation of when and how obscurants exist.

The example embodiments assume that data will be obtained on a per-pixel or per region basis. It is possible that subsampling or supersampling may be employed at one or more of the processing stages in each embodiment.

The images being processed in the embodiments herein should be of a sufficient resolution to ensure that the data being analyzed is of a good enough quality, so that a good determination may be made as to when an area of the image has structure data indicative of the existence of structure at that area.

As variations on the illustrated embodiments, the processing or functions performed by the disclosed elements, e.g., shown in FIG. 1, may be performed by a general purpose computer and/or by a specialized processing computer. Such processing or functions may be performed by a single platform or by a distributed processing platform. In addition, such processing or functions can be implemented in the form of special purpose hardware or in the form of software run by a computer. Any data handled in such processing or created as a result of such processing can be stored in any type of memory. By way of example, such data may be stored in a temporary memory, such as in the RAM of a given computer. In addition, or in the alternative, such data may be stored in longer-term storage devices, for example, magnetic disks, rewritable optical disks, and so on. For the disclosure herein, a machine readable media comprise any form of data storage mechanism, including the above-noted different memory technologies as well as hardware or circuit representations of such structures and of such data.

The claims, as originally presented and as they may be amended, encompass variations, alternatives, modifications, improvements, equivalents, and substantial equivalents of the embodiments and the teachings disclosed herein, including those that are presently unforeseen or unappreciated, and that, for example, may arise from applicants/patentees, and others.

What is claimed is:

1. Apparatus comprising:
memory;
at least one processor;
computer-readable media including first representations of camera diagnostics code configured to, when interoperably read by the at least one processor, form a camera diagnostics system, and second representations of other code including machine vision code, the machine vision code being configured to, when interoperably read by the at least one processor, form a machine vision system;
an image acquirer assembly configured to take two-dimensional pixel source images;
source images for the camera diagnostics system and for the machine vision system;
the source images each having been acquired by image acquirer assembly, and at least a portion of one or more of the source images being stored in the memory;
the camera diagnostics system including an obscurant detector configured to determine when the source images include artifacts representative of one or more obscurants intercepting a light path between a target object substantially remote from the image acquirer assembly and an imaging plane in the image acquirer assembly, the obscurant detector including a structure data determiner configured to analyze the source images and to produce structure data indicative of the existence of structure at different areas in the source images; and
the machine vision system including machine vision tools configured to locate and analyze the target object in the source images when the target object is not obscured by the one or more obscurants.

2. The apparatus according to claim 1, further comprising a vehicle mount configured to mount at least the image acquirer assembly to a movable vehicle.

3. Apparatus comprising:
image storage configured to receive, and to store at least a portion of one or more of, plural images including two-dimensional images;
a structure data determiner configured to analyze two-dimensional images from among the plural images and to produce structure data indicative of the existence of structure at different areas in the two-dimensional image;
a comparator configured to compare one or more first images of the plural images to one or more second images of the plural images, the one or more second images having been taken at times different than when the one or more first images were taken, and configured to determine an extent to which given structure data at a given location common to the first and second images has changed substantially from the one or more first images to the one or more second images; and
an obscurant determiner configured to determine when a obscurant exists at the given location based on factors, wherein a substantial change in a given value of the given structure data is a factor in favor of a determination that an obscurant exists at the given location, and wherein an insubstantial change in the given value of the given structure data is a factor in favor of a determination that an obscurant does not exist at the given location, wherein a change in the given value is deemed to be substantial when it exceeds a substantiality threshold value, and wherein a change in the given value is deemed to be insubstantial when it is below an insubstantiality threshold value.

4. The apparatus according to claim 3, wherein the structure data includes high spatial frequency components.

5. The apparatus according to claim 3, wherein the structure data includes edge-based values.

6. The apparatus according to claim 3, wherein the structure data includes pixel intensity statistics.

7. The apparatus according to claim 3, further comprising a speed input configured to receive speed-related data related to a current velocity of movement of a camera taking the images relative to target objects, wherein the factors further include the speed-related data.

8. The apparatus according to claim 7, further including a vehicle mounted camera, wherein the camera taking the images includes the vehicle mounted camera, the speed-related data including a vehicle speed value.

9. The apparatus according to claim 3, further comprising a rate-of-turn input configured to receive rate-of-turn related data related to a rate of change in yaw positioning of a camera taking the images, wherein the factors further include the rate-of-turn related data.

10. The apparatus according to claim 9, further comprising a vehicle mounted camera, wherein the camera taking the images includes the vehicle mounted camera, the rate-of-turn related data including a vehicle turn rate value.

11. The apparatus according to claim 3, further comprising a time of day input configured to receive time of day data, wherein the factors further include the time of day data.

12. The according to claim 3, further comprising an image region determiner, configured to determine an image region, from among a predetermined set of image regions, within which the given location is located, wherein the factors further include which image region, among the predetermined image regions, is where the given location is located.

13. Apparatus comprising:
image storage configured to receive, and to store at least a portion of one or more of, plural images including two-dimensional images;
a structure data determiner configured to analyze two-dimensional images from among the plural images and to produce structure data indicative of the existence of structure at different areas in the two-dimensional image; and
a condensation determiner configured to determine when condensation exists at the given location based on factors, wherein the given structure data including a value exceeding a substantial structure threshold is a factor in favor of a determination that no condensation exists at the given location, and wherein the given structure data including a value below an insubstantial structure threshold is a factor in favor of a determination that condensation does exist at the given location.

14. The apparatus according to claim 13, wherein the structure data includes high spatial frequency components.

15. The apparatus according to claim 13, wherein the structure data includes edge-based values.

16. The apparatus according to claim 13, wherein the structure data includes pixel intensity statistics.

17. The apparatus according to claim 13, further comprising an aggregator configured to aggregate the structure data for the different areas throughout the image into a smaller set of the structure data for a number of regions of the image, each of the regions encompassing a plurality of the different areas.

18. The apparatus according to claim 13, further comprising an image region determiner configured to determine an image region, from among a predetermined set of image regions, within which the given location is located, wherein the factors further include which image region, among the predetermined image regions, is where the given location is located.
